(19) United States
(12) Patent Application Publication
(10) Pub. No.: US 2024/0325956 A1
(43) Pub. Date: Oct. 3, 2024

(54) HONEYCOMB FILTER

(71) Applicant: NGK INSULATORS, LTD., Nagoya-City (JP)

(72) Inventor: Sachiko MASUDA, Nagoya-Shi (JP)

(73) Assignee: NGK INSULATORS, LTD., Nagoya-City (JP)

(21) Appl. No.: 18/581,618

(22) Filed: Feb. 20, 2024

(30) Foreign Application Priority Data
Mar. 28, 2023 (JP) 2023-051824

(51) Int. Cl. B01D 46/24; B01D 53/94; B01J 21/04; B01J 35/57

(52) U.S. Cl. CPC B01D 46/2474; B01D 46/2429; B01D 46/24491; B01D 46/24492; B01D 46/2482; B01D 46/2484; B01D 46/249; B01D 53/94; B01J 21/04; B01J 35/57; B01D 2255/2092; B01D 2255/9155; B01D 2258/01; B01D 2279/30

(57) ABSTRACT

A honeycomb filter includes a pillar-shaped honeycomb structure having a porous partition wall disposed so as to surround a plurality of cells which serve as a fluid through channel extending from a first end face to a second end face; and a plugging portion provided at either an end on the first end face side or the second end face side of the cell; wherein a thickness of the partition wall is 203 to 254 μm, a porosity of the partition wall measured by the mercury press-in method is 55 to 70%, an average pore diameter of the partition wall measured by the mercury press-in method is 20 to 25 μm, and the partition wall has an average base material neck diameter of 11 to 18 μm for a base material neck part in which an actual part of a porous base material constituting the partition wall is locally narrowed.

### RELATED APPLICATIONS

The present application is an application based on JP 2023-051824 filed on Mar. 28, 2023 with Japan Patent Office, the entire contents of which are incorporated herein by reference.

### BACKGROUND OF THE INVENTION

### Field of the Invention

The present invention relates to a honeycomb filter. More specifically, the present invention relates to a honeycomb filter having high mechanical strength and capable of effectively suppressing an increase in pressure loss when a catalyst for purifying exhaust gas is loaded to use.

### Description of the Related Art

Conventionally, a honeycomb filter using a honeycomb structure has been known as a filter for trapping particulate matter in exhaust gas emitted from an internal combustion engine such as an automobile engine or a device for purifying toxic gas components such as CO, HC, NOx (see Patent Document 1). The honeycomb structure includes a partition wall made of porous ceramics such as cordierite and a plurality of cells defined by the partition wall. A honeycomb filter includes such a honeycomb structure provided with plugging portions so as to plug the open ends at the inflow end face side and the outflow end face side of the plurality of cells alternately. In other words, the honeycomb filter has a structure in which inflow cells having the inflow end face side open and the outflow end face side plugged and outflow cells having the inflow end face side plugged and the outflow end face side open are arranged alternately with the partition wall therebetween. In the honeycomb filter, the porous partition wall serves as a filter for trapping the particulate matter (e.g., soot) in exhaust gas. Hereinafter, the particulate matter contained in exhaust gas may be referred to as “PM”. The “PM” is an abbreviation for “Particulate Matter.”

The honeycomb filters for trapping PM in exhaust gas have been studied in various ways to reduce pressure loss thereof.
[Patent Document 1] JP-A-2002-219319

As a measure for reducing pressure loss of the honeycomb filter, various methods have been studied, such as a method of increasing a porosity of the partition wall and a method of reducing a thickness of the partition wall.

However, when the porosity of the partition wall is increased in order to reduce pressure loss of the honeycomb filter, there is a problem in that it becomes difficult to secure the material strength of the partition wall. Hereinafter, the above-described “increasing a porosity of the partition wall” may be referred to as “increasing porosity of the partition wall”. As an example of the increasing porosity of the partition wall, when the partition wall has a thickness of 216 μm and a cell density of 46.5 cells/cm², it may be difficult to set the isostatic strength, which is one of the guidelines for the mechanical strength of the honeycomb filter, to 1 MPa or higher unless a porosity of the partition wall is set to 63% or less.

In addition, although it is possible to reduce pressure loss to a certain extent by reducing a thickness of the partition wall, there is a problem in that it becomes difficult to secure the material strength of the partition wall as in the case of the above-described increasing porosity of the partition wall. Hereinafter, the above-described reducing a thickness of the partition wall may be referred to as thinning of partition wall. In addition, when increasing porosity and thinning of partition wall are used in combination, it becomes more difficult to secure the mechanical strength such as the isostatic strength of the honeycomb filter.

The present invention has been made in view of the problems of the prior arts described above. According to the present invention, there is provided a honeycomb filter having high mechanical strength and capable of effectively suppressing an increase in pressure loss when a catalyst for purifying exhaust gas is loaded to use.

### SUMMARY OF THE INVENTION

According to the present invention, a honeycomb filter described below is provided.

[1] A honeycomb filter including: a pillar-shaped honeycomb structure having a porous partition wall disposed so as to surround a plurality of cells which serve as a fluid through channel extending from a first end face to a second end face; and
a plugging portion provided at either an end on the first end face side or the second end face side of the cell; wherein
a thickness of the partition wall is 203 to 254 μm,
a porosity of the partition wall measured by the mercury press-in method is 55 to 70%,
an average pore diameter of the partition wall measured by the mercury press-in method is 20 to 25 μm, and
the partition wall has an average base material neck diameter of 11 to 18 μm for a base material neck part in which an actual part of a porous base material constituting the partition wall is locally narrowed.

[2] The honeycomb filter according to [1], wherein a pore volume rate of pores having a pore diameter of 10 μm or less is 0.1 to 3.0% with respect to the total pore volume of the partition wall measured by the mercury press-in method.

[3] The honeycomb filter according to [1] or [2], wherein a cell density of the honeycomb structure is 43.4 to 49.6 cells/cm².

[4] The honeycomb filter according to any one of [1] to [3], wherein the partition wall is made of a material containing cordierite as a main component.

[5] The honeycomb filter according to any one of [1] to [4], wherein a pore diameter D10 at which the cumulative pore volume is 10% of the total pore volume is 16 to 19 μm in a pore diameter distribution of the partition wall measured by the mercury press-in method.

The honeycomb filter of the present invention has high mechanical strength and can effectively suppress an increase in pressure loss when a catalyst for purifying exhaust gas is loaded to use.

### BRIEF DESCRIPTION OF THE DRAWINGS

FIG. 1 is a perspective view schematically showing an embodiment of a honeycomb filter according to the present invention as viewed from a first end face side.

FIG. 2 is a plan view of the honeycomb filter shown in FIG. 1 as viewed from a first end face side.

FIG. 3 is a sectional view schematically showing a section taken along the line A-A′ of FIG. 2.

### DESCRIPTION OF THE PREFERRED EMBODIMENTS

The following will describe embodiments of the present invention; however, the present invention is not limited to the following embodiments. Therefore, it should be understood that those created by adding changes, improvements or the like to the following embodiments, as appropriate, on the basis of the common knowledge of a person skilled in the art without departing from the spirit of the present invention are also covered by the scope of the present invention.

(1) Honeycomb filter:

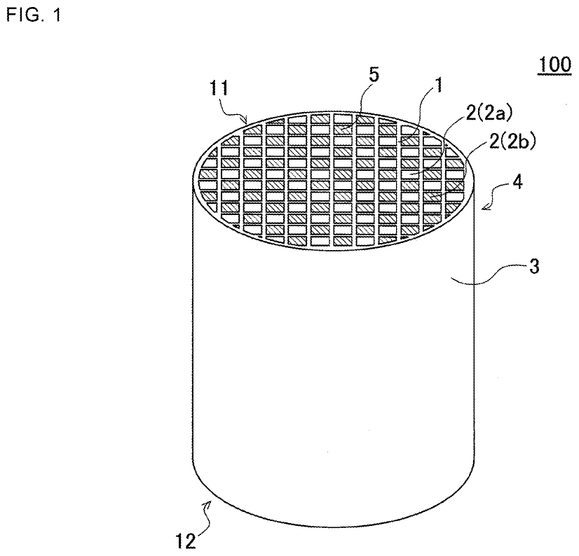

As shown in FIGS. 1 to 3, one embodiment of the honeycomb filter of the present invention is a honeycomb filter 100 including a honeycomb structure 4 and a plugging portion 5. The honeycomb structure 4 is of pillar-shaped having a porous partition wall 1 disposed so as to surround a plurality of cells 2 which serve as a fluid through channel extending from a first end face 11 to a second end face 12. In the honeycomb filter 100, the honeycomb structure 4 has a pillar shape, and further has a circumferential wall 3 on an outer peripheral side surface thereof. That is, the circumferential wall 3 is disposed so as to encompass the partition wall 1 arranged in a grid pattern.

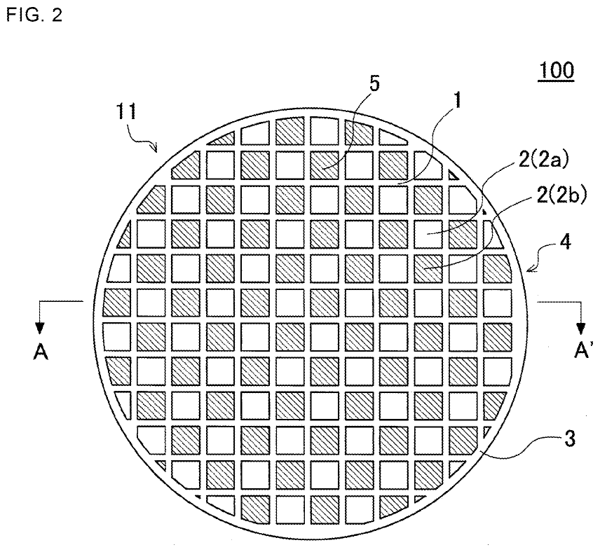

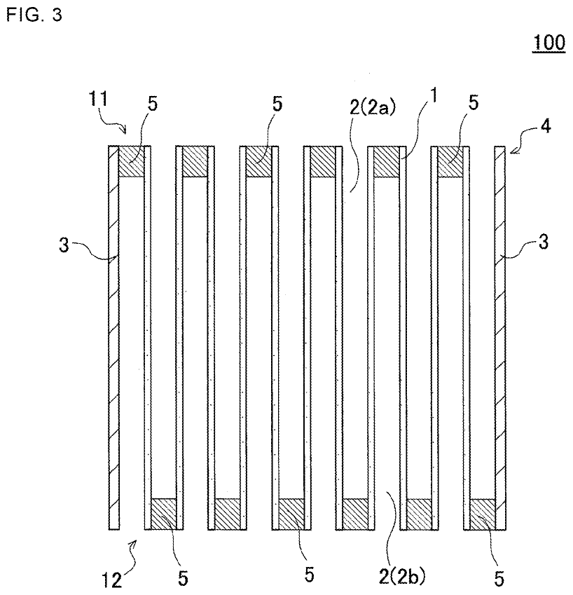

FIG. 1 is a perspective view schematically showing an embodiment of the honeycomb filter of the present invention as viewed from a first end face side (for example, an inflow end face side). FIG. 2 is a plan view of the honeycomb filter shown in FIG. 1 as viewed from a first end face side (for example, an inflow end face side). FIG. 3 is a sectional view schematically showing a section taken along the line A-A′ of FIG. 2.

The honeycomb filter 100 has particularly main properties in the configuration of the partition wall 1 constituting the honeycomb structure 4. That is, in the partition wall 1 constituting the honeycomb structure 4, a thickness of the partition wall 1 is 203 to 254 μm. In addition, a porosity of the partition wall 1 measured by the mercury press-in method is 55 to 70%, and an average pore diameter of the partition wall 1 measured by the mercury press-in method is 20 to 25 μm. Furthermore, the partition wall 1 has an average base material neck diameter of 11 to 18 μm for a base material neck part in which an actual part of a porous base material constituting the partition wall is locally narrowed. The honeycomb filter 100 configured as described above has high mechanical strength and can effectively suppress an increase in pressure loss when a catalyst for purifying exhaust gas is loaded to use. In particular, in the honeycomb filter 100 of the present embodiment, a thickness of the partition wall 1 is 203 to 254 μm, a porosity of the partition wall 1 is 55 to 70%, and a porous partition wall 1 can achieve excellent mechanical strength despite having a relatively high porosity and a thin wall. The reason is that the average pore diameter of the partition wall 1 is 20 to 25 μm, and the average base material neck diameter of the base material neck part described above is 11 to 18 μm. That is, in the partition wall 1 of the honeycomb filter 100 of the present embodiment, the base material neck part of the porous base material constituting the partition wall 1 is configured to be thicker than the base material neck part of the conventional porous base material, and the average base material neck diameter of the porous base material is 11 to 18 μm. Therefore, the porous base material constituting the partition wall 1 has high material strength, and excellent mechanical strength (for example, isostatic strength) can be realized. Hereinafter, the partition wall 1 constituting the honeycomb structure 4 will be described more specifically.

A thickness of the partition wall 1 is 203 to 254 μm. When the thickness of the partition wall 1 is less than 203 μm while satisfying another configuration other than the thickness of the partition wall 1 (for example, numerical values of the above-described porosity, average pore diameter, and the like), the mechanical strength of the partition wall 1 decreases. On the other hand, when the thickness of the partition wall 1 exceeds 254 μm, pressure loss of the honeycomb filter 100 may be increased when a catalyst for purifying exhaust gas is loaded on the partition wall 1. The thickness of the partition wall 1 may be 203 to 254 μm, for example, preferably 216 to 241 μm, and more preferably 224 to 236 μm. The thickness of the partition wall 1 can be measured, for example, using a scanning electron-microscope or a microscope.

A porosity of the partition wall 1 is 55 to 70%. The porosity of the partition wall 1 is measured by the mercury press-in method. The porosity of the partition wall 1 can be measured using, for example, Autopore 9500 (trade name) manufactured by Micromeritics. To measure the porosity, a part of the partition wall 1 is cut out from the honeycomb filter 100 to obtain a test piece, and the test piece thus obtained can be used. When the partition wall 1 has a porosity of less than 55%, pressure loss of the honeycomb filter 100 may be increased when a catalyst for purifying exhaust gas is loaded on the partition wall 1. When the partition wall 1 has a porosity exceeding 70%, the mechanical strength of the honeycomb filter 100 may be lowered. The porosity of the partition wall 1 may be 55 to 70%, for example, preferably 58 to 67%, and more preferably 60 to 65%.

An average pore diameter of the partition wall 1 is 20 to 25 μm. The average pore diameter of the partition wall 1 is measured by the mercury press-in method. The average pore diameter of the partition wall 1 can be measured using, for example, Autopore 9500 (trade name) manufactured by Micromeritics. The average pore diameter can be measured using the test piece used for the measurement of porosity described above. When the partition wall 1 has an average pore diameter of less than 20 μm, pressure loss of the honeycomb filter 100 may be increased when a catalyst for purifying exhaust gas is loaded on the partition wall 1. When the partition wall 1 has an average pore diameter exceeding 25 μm, filtration efficiency of the honeycomb filter 100 may be lowered. The average pore diameter of the partition wall 1 may be 20 to 25 μm, for example, preferably 23 to 25 μm, and more preferably 24 to 25 μm.

Further, in the honeycomb filter 100 of the present embodiment, the partition wall 1 has an average base material neck diameter of 11 to 18 μm for a base material neck part in which an actual part of a porous base material constituting the partition wall 1 is locally narrowed. By setting the average base material neck diameter of the base material neck part to 11 to 18 μm while satisfying other configurations related to the partition wall 1 such as porosity and average pore diameter described above, small pores of the porous base material that constitutes the partition wall 1 are reduced and the base material neck diameter of the porous base material is increased. Therefore, the honeycomb filter 100 of the present embodiment can effectively suppress an increase in pressure loss of the honeycomb filter 100 while suppressing a decrease in mechanical strength, particularly when a catalyst for purifying exhaust gas is loaded on the partition wall 1.

An average base material neck diameter of the base material neck part may be 11 to 18 μm, for example, preferably 13 to 18 μm, and more preferably 15 to 18 μm. When the average base material neck diameter is less than 11 μm, the mechanical strength may be lowered when other configurations related to partition wall 1 such as porosity and average pore diameter are satisfied. Further, if other configurations such as porosity and average pore diameter are adjusted to improve the mechanical strength, pressure loss of the honeycomb filter 100 may increase when a catalyst for purifying exhaust gas is loaded on the partition wall 1. On the other hand, when the average base material neck diameter exceeds 18 μm, the average pore diameter may be relatively large, and filtration efficiency of the honeycomb filter 100 may be lowered.

The average base material neck diameter of the base material neck part of the porous base material constituting the partition wall 1 can be measured as follows. First, a porous body data of the porous base material constituting the partition wall 1 is obtained on the basis of the three-dimensional scanning. Examples of the device used for the three-dimensional scanning include Xradia520Versa (trade name) manufactured by Carl Zeiss Co., Ltd. The resolution in each of the X, Y, and Z directions is 1.2 μm, and the resulting cube with 1.2 μm on one side is a voxel. The data obtained by the three-dimensional CT scanning is, for example, luminance data for each coordinate of X, Y, and Z. The three-dimensional porous body data (hereinafter, also referred to as “porous body three-dimensional data”) can be obtained by binarizing such luminance data at a predetermined threshold value and determining whether it is a spatial voxel or an object voxel for each coordinate. The threshold value is determined by Otsu's method, for example, from the luminance distribution of the luminance data. For example, the range in which the porous body data of the partition wall 1 is obtained is not particularly limited. The range in which the porous body data of the partition wall 1 is obtained can be appropriately determined according to the device used for the three-dimensional scanning, and examples thereof include a range of 480 μm×480 μm×thickness of the partition wall 1 (μm).

Next, the base material is divided by WaterShed method at the constricted part with respect to the obtained porous body three-dimensional data. The SNOW algorithm is implemented in the program, and the division by WaterShed method is carried out.

Then, for the divided base material obtained by dividing the base material at the constricted part, the “aggregate of voxels” between one divided base material and the other divided base material adjoining the one divided base material is defined as the “base material neck part” partitioning the base material from each other. A base material neck area is the value obtained by multiplying the number of voxels constituting the material neck part by the square of the grid resolution (1.2 μm) (i.e., the number of voxels×(1.2 μm)²). The average base material neck diameter is determined by √(base material neck area/π).

In the partition wall 1, it is preferable that a pore volume rate of pores having a pore diameter of 10 μm or less with respect to the total pore volume of the partition wall 1 measured by the mercury press-in method in pore is 0.1 to 3.0%. As described above, in the honeycomb filter 100 of the present embodiment, the porous base material constituting the partition wall 1 preferably has a small pore volume rate of pores having a relatively small diameter (small pores) having a pore diameter of 10 μm or less. A substantial lower limit of the pore volume rate of pores having a pore diameter of 10 μm or less is 0.1% as described above. As the small pore increases when the pore volume rate of pores having a pore diameter of 10 μm or less exceeds 3.0%, an average base material neck diameter of the base material neck part becomes difficult to increase. Therefore, it may be difficult to keep the average base material neck diameter of the base material neck part within the range of 11 to 18 μm. The pore volume rate of pores having a pore diameter of 10 μm or less with respect to the total pore volume of the partition wall 1 can be measured by the same measuring method as the porosity and the average pore diameter of the partition wall 1, for example, using Autopore 9500 (trade name) manufactured by Micromeritics. Although not particularly limited, it is further preferable that a pore volume rate of pores having a diameter of 10 μm or less with respect to the total pore volume of the partition wall 1 is 0.1 to 2.0%, for example.

Further, in the partition wall 1 of the honeycomb filter 100 of the present embodiment, it is preferable that the pore diameter D10 at which the cumulative pore volume is 10% of the total pore volume in the pore diameter distribution of the partition wall 1 measured by the mercury press-in method is 16 to 19 μm. Hereinafter, the above-described “pore diameter D10 at which the cumulative pore volume is 10% of the total pore volume” may be referred to as “D10” in the pore diameter distribution of the partition wall 1. In the honeycomb filter 100 of the present embodiment, it is preferable that D10 of the above-described pore diameter distribution is set to be relatively high, such as 16 to 19 μm. By setting D10 in the pore diameter distribution to be high and reducing small pores, the transmission resistivity of the partition wall 1 is lowered, and an increase in pressure loss of the honeycomb filter 100 can be effectively suppressed. It is further preferable that D10 in the pore diameter distribution is 18 to 19 μm, for example.

The cumulative pore volume of the partition wall 1 is measured by the mercury press-in method as described above. The cumulative pore volume of the partition wall 1 can be measured using, for example, Autopore 9500 (trade name) manufactured by Micromeritics. The cumulative pore volume of the partition wall 1 can be measured by the following method. First, a part of the partition wall 1 is cut out from the honeycomb filter 100 to make a test piece for measuring the cumulative pore volume. The size of the test piece is not particularly limited, but for example, the test piece is preferably, for example, a rectangular parallelepiped having a length, a width, and a height of approximately 10 mm, approximately 10 mm, and approximately 20 mm, respectively. A part of the partition wall 1 from which the test piece is cut out is not particularly limited, but the test piece is preferably made by cutting out from the vicinity of the axial center of the honeycomb structure 4 of the honeycomb filter 100. The obtained test piece is placed in a measurement cell of a measurement device, and the interior of the measurement cell is depressurized. Next, mercury is introduced into the measurement cell. Next, the mercury introduced into the measurement cell is pressurized, and the volume of the mercury pushed into the pores existing in the test piece is measured during the pressurization. At this time, as the pressure applied to the mercury is increased, the mercury is pushed into pores progressively from pores having a larger pore diameter and then to pores having a smaller pore diameter. Therefore, the relationship between the “pore diameter of pores formed on the test piece” and the “cumulative pore volume” can be determined from the relationship between the “pressure applied to the mercury” and the “volume of the mercury pushed into the pores”. More specifically, as described above, when a pressure is gradually applied to the mercury in order to intrude into the pores of the sample (test piece) in a container sealed in a vacuum state by the mercury press-in method, the pressurized mercury intrudes into the larger pores and then into the smaller pores of the sample. Based on the pressure and the amount of mercury intruded at that time, the pore diameter and the pore volume of pores formed in the sample can be calculated. Hereinafter, when pore diameters are denoted by a1, a2, a3 . . . , the relationship of a1>a2>a3 . . . is to be satisfied. Here, the average pore diameter between the respective measuring points (e.g., a1 to a2) can be indicated on the horizontal axis as “average pore diameter=(a1+a2)/2”. In addition, the Log differential pore volume on the vertical axis may be a value obtained by dividing an increment dV of the pore volume between the respective measuring points by a difference value treated as the logarithms of the pore diameter (i.e., “log(a1)−log(a2)”).

The shape of the cells 2 formed in the honeycomb structure 4 is not particularly limited. For example, the shape of the cells 2 in a section orthogonal to the extending direction of the cell 2 may include a polygonal shape, a circular shape, an elliptical shape, and the like. Examples of the polygonal shape include a triangle, a quadrangle, a pentagon, a hexagon, and an octagon. The shape of the cell 2 is preferably a triangle, a quadrangle, a pentagon, a hexagon, or an octagon. Moreover, regarding the shapes of the cell 2, all the cells 2 may have the same or different shapes. For example, although not shown, quadrangular cells and octagonal cells may be mixed. Further, regarding the sizes of the cells 2, all the cells 2 may have the same size or different sizes. For example, although not shown, among the plurality of cells, some cells may be made to be large, and other cells may be made to be relatively smaller. In the present invention, the cell 2 means a space surrounded by the partition wall 1.

The cell density of the cell 2 defined by the partition wall 1 is preferably 43.4 to 49.6 cells/cm², more preferably 45.0 to 48.1 cells/cm². With this configuration, the honeycomb filter 100 can be suitably used as a filter for purifying exhaust gas emitted from an automobile engine.

The partition wall 1 is preferably made of a porous material of ceramics, and more preferably a material containing cordierite as a main component. That is, it is more preferable that the partition wall 1 is a porous base material made of a material containing cordierite as a main component. Here, the “main component” means a component present in the component in an amount of 90% by mass or more. The material constituting the partition wall 1 preferably contains cordierite in an amount of 92% by mass or more, and more preferably 94% by mass or more. It is particularly preferable that partition wall 1 is made of cordierite except for components inevitably contained therein.

The circumferential wall 3 of the honeycomb structure 4 may be formed integrally with the partition wall 1, or may be a circumferential coating layer formed by applying a circumferential coating material to the circumferential side of the partition wall 1. For example, although not shown, the circumferential coating layer can be provided on the circumferential side of the partition wall after the partition wall and the circumferential wall are integrally formed and then the formed circumferential wall is removed by a known method, such as grinding, at the time of manufacturing.

The shape of the honeycomb structure 4 is not particularly limited. The shape of the honeycomb structure 4 may be a pillar-shape in which the shape of the first end face 11 (e.g., inflow end face) and the shape of the second end face 12 (e.g., outflow end face) includes a circular shape, an elliptical shape, a polygonal shape, or the like.

The size of the honeycomb structure 4, for example, the length from the first end face 11 to the second end face 12, and the size of a section orthogonal to the extending direction of the cells 2 of the honeycomb structure 4, is not particularly limited. Each size may be appropriately selected so as to obtain optimum purification performance when the honeycomb filter 100 is used as a filter for purifying exhaust gas.

In the honeycomb filter 100, plugging portions 5 are provided at the open ends on the first end face 11 side of the predetermined cells 2 and at the open ends on the second end face 12 side of the remaining cells 2. Here, when the first end face 11 is defined as an inflow end face and the second end face 12 is defined as an outflow end face, the cell 2 in which an open end on the outflow end face side is provided with a plugging portion 5 and the inflow end face side is opened is defined as an inflow cell 2a. In addition, the cell 2 in which an open end on the inflow end face is provided with a plugging portion 5 and the outflow end face side is opened is defined as an outflow cell 2b. The inflow cell 2a and the outflow cell 2b are preferably arranged alternately with the partition wall 1 therebetween. Thereby, it is preferable that a checkerboard pattern is formed on both end faces of the honeycomb filter 100 by the plugging portions 5 and the “open ends of the cells 2”.

The material of the lugging portion 5 is not particularly limited. For example, the material may be the same as the material of the partition wall 1 described above, or may be a material different from the material of the partition wall 1.

In the honeycomb filter 100, the partition wall 1 defining a plurality of cells 2 is preferably loaded with a catalyst for purifying exhaust gas. The “partition wall 1 is loaded with a catalyst” means that the catalyst is coated on the surface of the partition wall 1 and the inner wall of the pore formed on the partition wall 1. With this configuration, CO, NOx, HC, and the like in exhaust gas can be made harmless by a catalytic reaction. In addition, oxidization of PM such as soot trapped can be promoted.

The catalyst loaded on the partition wall 1 is not particularly limited. For example, such catalysts may include a catalyst containing a platinum group element and containing an oxide of at least one element among aluminum, zirconium, and cerium. The loading amount of the catalyst is preferably 50 to 100 g/L. In this specification, the loading amount (g/L) of the catalyst indicates the amount (g) of the catalyst loaded per unit volume (L) of the honeycomb filter 100.

### (2) Manufacturing Method of Honeycomb Filter:

The manufacturing method of the honeycomb filter of the present embodiment shown in FIGS. 1 to 3 is not particularly limited, and the honeycomb filter can be manufactured by the following method, for example. First, a plastic kneaded material for making a honeycomb structure is prepared. The kneaded material for making a honeycomb structure can be prepared, for example, as follows. As raw material powders, talc, alumina, aluminum hydroxide, silica, and the like can be used, and these raw material powders can be prepared so as to have a chemical composition of 42 to 56% by mass of silica, 30 to 45% by mass of alumina, and 12 to 16% by mass of magnesia.

In the honeycomb filter of the present embodiment, an average base material neck diameter of a base material neck part of the porous base material constituting the partition wall is 11 to 18 μm. As a manufacturing method of such a honeycomb filter, for example, in the preparation of the kneaded material, it is preferable to prepare the kneaded material without using kaolin conventionally used as a raw material powder of the kneaded material as a raw material. In particular, kaolin generally has a small raw material particle size, and by using a kneaded material prepared using a raw material powder containing no kaolin having such a small raw material particle size, the average base material neck diameter of the base material neck part can be made larger than that of the porous base material manufactured by a conventional manufacturing method. For example, talcum with a particle size of 15 to 25 μm, alumina with a particle size of 4 to 8 μm, and the like can be used as raw material.

Next, the kneaded material thus obtained is subjected to extrusion so as to make a honeycomb formed body having a partition wall defining a plurality of cells and a circumferential wall disposed so as to encompass the partition wall.

The obtained honeycomb formed body is dried, for example, by microwave and hot air, and an open end of the cell is plugged with a material similar to the material used for making the honeycomb formed body to provide a plugging portion. After forming the plugging portion, the honeycomb formed body may be further dried.

Next, a honeycomb filter is manufactured by firing the honeycomb formed body in which a plugging portion is formed. The firing temperature and the firing atmosphere differ according to the raw material, and those skilled in the art can select the firing temperature and the firing atmosphere that are the most suitable for the selected material.

### EXAMPLES

Hereinafter, the present invention will be described in more detail by examples, but the present invention is not at all limited by these examples.

### Example 1

A kneaded material is prepared by adding 3.4 parts by mass of a pore former, 1.0 parts by mass of a dispersing medium, and 6.0 parts by mass of an organic binder to 100 parts by mass of a cordierite forming raw material, and mixing and kneading them. As the organic binder, methylcellulose was used. As the dispersing agent, potassium laurate soap was used. As the pore former, a water-absorbing polymer with an average particle diameter of 30 μm was used. As the cordierite forming raw material, talcum, alumina, silica gel, and aluminum hydroxide were used.

Next, the obtained kneaded material was molded using an extruder to make a honeycomb formed body. Next, the obtained honeycomb formed body was dried by high frequency dielectric heating and then further dried using a hot air dryer. The shape of the cells in the honeycomb formed body was quadrangular.

Next, a plugging portion was formed on the dried honeycomb formed body. First, the inflow end face of the honeycomb formed body was masked. Next, an end portion provided with a mask (the end portion on the inflow end face side) was immersed in a plugging slurry, and the plugging slurry was filled into an open end of the cell without the mask (the outflow cell). In this way, a plugging portion was formed on the inflow end face of the honeycomb formed body. Then, the plugging portion was also formed in the inflow cell in the same manner for the outflow end face of the dried honeycomb formed body.

Next, the honeycomb formed body on which the plugging portions have been formed was dried with a microwave dryer and completely dried with a hot air dryer, and then both end faces of the honeycomb formed body were cut and adjusted to a predetermined size. The dried honeycomb formed body was then degreased and calcined to manufacture a honeycomb filter of Example 1.

The honeycomb filters of Example 1 had a diameter of the end face of 118.4 mm and a length in the extending direction of the cells of 152.4 mm. The thickness of the partition wall was 203.2 μm and a cell density was 41.9 cells/cm².

For the honeycomb filter of Example 1, the porosity (%) and the average pore diameter (μm) of the partition wall were measured by the following method. In addition, using a device used for measuring the porosity and the average pore diameter shown below, a pore diameter distribution of the partition wall was obtained, and the obtained pore diameter distribution was used to determine a pore volume rate (%) of pores having a pore diameter of 10 μm or less with respect to the total pore volume, and the pore diameter D10 (μm) at which the cumulative pore volume is 10% of the total pore volume. In addition, the average base material neck diameter (μm) of the base material neck part of the porous base material constituting the partition wall was determined by the following method. The results are shown in Table 1.

TABLE 1

| | | | | Average | | Pore | |
|---|---|---|---|---|---|---|---|
| | | | | base | | volume rate | |
| | | Partition | Average | material | Cell | of pores | |
| | | wall | pore | neck | density | of 10 μm | |
| | Porosity | Thickness | diameter | diameter | (cells/ | or less | D10 |
| | (%) | (μm) | (μm) | (μm) | cm²) | (%) | (μm) |
| Comparative | 60 | 215.9 | 19 | 8 | 46.5 | 15 | 8 |
| Example 1 | | | | | | | |
| Comparative | 65 | 215.9 | 24 | 10 | 45.0 | 12.5 | 10 |
| Example 2 | | | | | | | |
| Comparative | 60 | 215.9 | 17 | 12 | 46.5 | 15 | 8 |
| Example 3 | | | | | | | |
| Comparative | 71 | 215.9 | 22 | 13 | 49.6 | 15 | 8 |
| Example 4 | | | | | | | |
| Comparative | 54 | 215.9 | 23 | 11 | 46.5 | 13.75 | 9 |
| Example 5 | | | | | | | |
| Comparative | 63 | 266.7 | 21 | 12 | 48.1 | 16.25 | 7 |
| Example 6 | | | | | | | |
| Comparative | 66 | 190.5 | 23 | 12 | 46.5 | 12.5 | 10 |
| Example 7 | | | | | | | |
| Example 1 | 56 | 203.2 | 24 | 15 | 41.9 | 15 | 8 |
| Example 2 | 65 | 203.2 | 24 | 15 | 41.9 | 15 | 8 |
| Example 3 | 69 | 203.2 | 24 | 15 | 41.9 | 15 | 8 |
| Example 4 | 65 | 203.2 | 23 | 11 | 49.6 | 12.5 | 10 |
| Example 5 | 65 | 203.2 | 23 | 14 | 49.6 | 12.5 | 10 |
| Example 6 | 65 | 203.2 | 23 | 16 | 49.6 | 12.5 | 10 |
| Example 7 | 65 | 203.2 | 23 | 13 | 49.6 | 2.5 | 18 |
| Example 8 | 65 | 203.2 | 23 | 13 | 49.6 | 5 | 16 |

[Porosity (0%) and Average Pore Diameter (μm)]

The porosity and the average pore diameter of the partition wall were measured using Autopore 9500 (trade name) manufactured by Micromeritics. In the measurement of the porosity and the average pore diameter, a part of the partition wall was cut out from the honeycomb filter to obtain a test piece, and the porosity was measured using the obtained test piece. The test piece was a rectangular parallelepiped having a length, a width, and a height of approximately 10 mm, approximately 10 mm, and approximately 20 mm, respectively. The sampling location of the test piece was set in the vicinity of the center of the honeycomb filter in the axial direction.

[Average Base Material Neck Diameter (μm)]

First, the porous body three-dimensional data of the partition wall was measured by three-dimensional scanning. The three-dimensional scanning was performed using Xradia520Versa (trade name) manufactured by Carl Zeiss Co., Ltd. In the porous body three-dimensional data, the resolution in each of the X, Y, and Z directions is 1.2 μm, and the resulting cube with 1.2 μm on one side is a voxel. The porous body three-dimensional data is luminance data for each coordinate of X, Y, and Z. Next, the base material was divided by WaterShed method at the constricted part with respect to the porous body three-dimensional data. The SNOW algorithm was implemented in the program, and the division by WaterShed method was carried out. For the divided base material obtained by dividing the base material as described above, the aggregate of voxels between two neighboring divided base materials is defined as a base material neck part. A base material neck area is the value obtained by multiplying the number of voxels constituting the material neck part by the square of the grid resolution (1.2 μm) (i.e., the number of voxels×(1.2 μm)²), and the average base material neck diameter was determined by √(base material neck area/π).

The honeycomb filter of Example 1 was evaluated for the A-axis compressive strength and the pressure loss by the following method. In the respective evaluations of the A-axis compressive strength and the pressure loss, each honeycomb filter to be evaluated was loaded with the platinum-group element-containing catalyst by the following method and measured after loading the catalyst. The results are shown in Table 2.

TABLE 2

| | Measured value | | Rate of change | | | |
|---|---|---|---|---|---|---|
| | A-axis | | A-axis | | Judgment | |
| | compressive | Pressure | compressive | Pressure | A-axis | |
| | strength | loss | strength ratio | loss ratio | compressive | |
| | (MPa) | (KPa) | (%) | (%) | strength | Pressure loss |
| Comparative | 10 | 30.0 | Reference | Reference | — | — |
| Example 1 | | | | | | |
| Comparative | 9.3 | 27.3 | 93 | 91 | Fail | Acceptable |
| Example 2 | | | | | | |
| Comparative | 14 | 30.0 | 140 | 100 | Good | Fail |
| Example 3 | | | | | | |
| Comparative | 9.9 | 27.7 | 99 | 92 | Fail | Acceptable |
| Example 4 | | | | | | |
| Comparative | 16 | 30.2 | 160 | 101 | Excellent | Fail |
| Example 5 | | | | | | |
| Comparative | 14.7 | 30.1 | 147 | 100 | Good | Fail |
| Example 6 | | | | | | |
| Comparative | 10 | 27.2 | 100 | 91 | Fail | Acceptable |
| Example 7 | | | | | | |
| Example 1 | 17.9 | 30.0 | 179 | 100 | Excellent | Acceptable |
| Example 2 | 13.4 | 28.2 | 134 | 94 | Good | Acceptable |
| Example 3 | 11.4 | 27.4 | 114 | 91 | Acceptable | Acceptable |
| Example 4 | 10.4 | 27.6 | 104 | 92 | Acceptable | Acceptable |
| Example 5 | 13.4 | 27.6 | 134 | 92 | Good | Acceptable |
| Example 6 | 15.4 | 27.6 | 154 | 92 | Excellent | Acceptable |
| Example 7 | 12.4 | 23.0 | 124 | 77 | Good | Excellent |
| Example 8 | 12.4 | 24.2 | 124 | 81 | Good | Good |

### [Catalyst Loading Procedure]

First, a catalyst slurry containing aluminum oxide having an average particle diameter of 30 μm was prepared. The catalyst was then loaded on the honeycomb filter using the prepared catalyst slurry. Specifically, loading of the catalyst was performed by dipping the honeycomb filter, and then a predetermined amount of the catalyst was loaded on the partition wall of the honeycomb filter by blowing off the excess catalyst slurry by air. Thereafter, the honeycomb filter loaded with the catalyst was dried at 100° C., and further subjected to a heat treatment at 500° C. for 2 hours to obtain a honeycomb filter with a catalyst. The loading amount of the catalyst loaded on the honeycomb filter of Example 1 was 75 g/L.

### [A-Axis Compressive Strength]

A test piece having a diameter of about 25.4 mm and a length of 25.4 mm cut out from a product (honeycomb filter) was used as a sample, and a load is continuously applied at a head speed of 1 mm/min or less of the test machine. The load F at the time of fracture was read, the compressive strength P was calculated by the following equation (1), and the A-axis compressive strength (MPa) of the honeycomb filter was obtained. In the column of “A-axis compressive strength ratio” in Table 2, the values (%) of the A-axis compressive strength are shown for the honeycomb filters with a catalyst of each example and comparative example, when the value of the A-axis compressive strength of the honeycomb filter with a catalyst of Comparative Example 1 is set to 100%. In the evaluation of the A-axis compressive strength, the honeycomb filter of each example was evaluated based on the following evaluation criteria.

P=F/S (1)
(In the above equation (1), P represents a compressive strength (Pa), F represents a load (N) at the time of fracture, S represents a sample sectional area (m²). Incidentally, the sample sectional area S was 5.067×10⁻⁴ m²).
Evaluation “Excellent”: When the value of the A-axis compressive strength ratio (%) is 150% or more, the evaluation is regarded as “Excellent”.
Evaluation “Good”: When the value of the A-axis compressive strength ratio (%) is 120% or more and less than 150%, the evaluation is regarded as “Good”.
Evaluation “Acceptable”: When the value of the A-axis compressive strength ratio (%) is 100% or more and less than 120%, the evaluation is regarded as “Acceptable”.
Evaluation “Fail”: When the value of the A-axis compressive strength ratio (%) is less than 100%, the evaluation is regarded as “Fail”.

### [Pressure Loss]

Exhaust gas emitted from a 1.2 L direct injection type gasoline engine was flowed in at a flow rate of 600 m³/h at 700° C. to measure the pressure between the inflow end face side and the outflow end face side of the honeycomb filter with a catalyst. Then, pressure loss (kPa) of the honeycomb filter was determined by calculating the pressure difference between the inflow end face side and the outflow end face side. In the column of “Pressure loss ratio” in Table 2, the values (%) of pressure loss are shown for the honeycomb filters with a catalyst of each example and comparative example, when the value of pressure loss of the honeycomb filter with a catalyst of Comparative Example 1 is set to 100%. In the pressure loss evaluation, the honeycomb filter of each example was evaluated based on the following evaluation criteria.
Evaluation “Excellent”: When the value of pressure loss ratio (%) is 80% or less, the evaluation is regarded as “Excellent”.
Evaluation “Good”: When the value of pressure loss ratio (%) exceeds 80% and is 90% or less, the evaluation is regarded as “Good”.
Evaluation “Acceptable”: When the value of pressure loss ratio (%) exceeds 90% and is 100% or less, the evaluation is regarded as “Acceptable”.
Evaluation “Fail”: When the value of pressure loss ratio (%) exceeds 100%, the evaluation is regarded as “Fail”.

### Examples 2 to 8

In Examples 2 to 8, the honeycomb filters were manufactured using raw materials as shown below in the preparation of the kneaded material for making a honeycomb formed body. For the obtained honeycomb filter, the porosity and the average pore diameter of the partition wall were measured in the same manner as in Example 1. In addition, the pore volume rate (%), D10 (μm), and the average base material neck diameter (μm) of pores of 10 μm or less were determined by the above-described method. The results are shown in Table 1. In Examples 2 to 8, a raw material powder containing no kaolin was used in the raw material powder for preparing the kneaded material.

### Comparative Examples 1 to 7

In Comparative Examples 1 to 7, the honeycomb filters were manufactured using raw materials as shown below in the preparation of the kneaded material for making a honeycomb formed body. For the obtained honeycomb filter, the porosity and the average pore diameter of the partition wall were measured in the same manner as in Example 1. In addition, the pore volume rate (%), D10 (μm), and the average base material neck diameter (μm) of pores of 10 μm or less were determined by the above-described method. The results are shown in Table 1. In Comparative Examples 1 and 2, a raw material powder containing kaolin was used in the raw material powder for preparing the kneaded material. In Comparative Examples 3 to 7, a raw material powder containing no kaolin was used in the raw material powder for preparing the kneaded material, and the particle size of the raw material powder and the particle size of the pore former were adjusted so that the porosity and the average pore diameter of the partition wall were as shown in Table 1.

The honeycomb filters of Examples 2 to 8 and Comparative Examples 1 to 7 were evaluated for A-axis compressive strength and pressure loss in the same manner as in Example 1. The results are shown in Table 2.

### Results

The honeycomb filters of Examples 1 to 8 were superior to the honeycomb filter of Comparative Example 1 as an evaluation criterion in the evaluations of A-axis compressive strength and pressure loss. In particular, the honeycomb filter of Example 1 had a base material neck diameter of 15 μm, and the evaluation result of A-axis compressive strength was particularly excellent. In addition, the honeycomb filter of Example 6 had a base material neck diameter of 16 μm, and the evaluation result of A-axis compressive strength was also particularly excellent. The honeycomb filter of Example 7 had a pore volume rate of pores of 10 μm or less of 2.5%, and the evaluation result of pressure loss was particularly excellent.

On the other hand, the honeycomb filter of Comparative Example 2 had an average base material neck diameter of 10 μm and a porosity of 65%, and the evaluation result of A-axis compressive strength was inferior to the honeycomb filter of Comparative Example 1, which was an evaluation criteria. The honeycomb filter of Comparative Example 3 had an average pore diameter of 17 μm, and the evaluation result of pressure loss after loading catalyst (hereinafter, also referred to as catalyst coating) was inferior to the honeycomb filter of Comparative Example 1, which was an evaluation criteria. The honeycomb filter of Comparative Example 4 had a porosity of 71%, and the evaluation result of A-axis compressive strength was inferior to the honeycomb filter of Comparative Example 1, which was an evaluation criteria. The honeycomb filter of Comparative Example 5 had a porosity of 54%, and the evaluation result of pressure loss after catalyst coating was inferior to the honeycomb filter of Comparative Example 1, which was an evaluation criteria. The honeycomb filter of Comparative Example 6 had a partition wall thickness of 266.7 μm, and the evaluation result of pressure loss after catalyst coating was inferior to the honeycomb filter of Comparative Example 1, which was an evaluation criteria. The honeycomb filter of Comparative Example 7 had a partition wall thickness of 190.5 μm, and the evaluation result of A-axis compressive strength was inferior to the honeycomb filter of Comparative Example 1, which was an evaluation criteria.

### INDUSTRIAL APPLICABILITY

The honeycomb filter of the present invention can be used as a trapping filter for removing fine particles and the like contained in exhaust gas.

### DESCRIPTION OF REFERENCE NUMERALS

1: partition wall, 2: cell, 2a: inflow cell, 2b: outflow cell, 3: circumferential wall, 4: honeycomb structure, 5: plugging portion, 11: first end face, 12: second end face, and 100: honeycomb filter.

What is claimed is:

1. A honeycomb filter comprising: a pillar-shaped honeycomb structure having a porous partition wall disposed so as to surround a plurality of cells which serve as a fluid through channel extending from a first end face to a second end face; and
a plugging portion provided at either an end on the first end face side or the second end face side of the cell; wherein
a thickness of the partition wall is 203 to 254 μm,
a porosity of the partition wall measured by the mercury press-in method is 55 to 70%,
an average pore diameter of the partition wall measured by the mercury press-in method is 20 to 25 μm, and
the partition wall has an average base material neck diameter of 11 to 18 μm for a base material neck part in which an actual part of a porous base material constituting the partition wall is locally narrowed.

2. The honeycomb filter according to claim 1, wherein a pore volume rate of pores having a pore diameter of 10 μm or less is 0.1 to 3.0% with respect to the total pore volume of the partition wall measured by the mercury press-in method.

3. The honeycomb filter according to claim 1, wherein a cell density of the honeycomb structure is 43.4 to 49.6 cells/cm².

4. The honeycomb filter according to claim 1, wherein the partition wall is made of a material containing cordierite as a main component.

5. The honeycomb filter according to claim 1, wherein a pore diameter D10 at which the cumulative pore volume is 10% of the total pore volume is 16 to 19 μm in a pore diameter distribution of the partition wall measured by the mercury press-in method.
